(19) United States
(12) Patent Application Publication
(10) Pub. No.: US 2006/0153132 A1
(43) Pub. Date: Jul. 13, 2006

(54) Method of medium access control for a wireless system and a relay station used in a wireless system

(75) Inventor: Kenji Saito, Saitama (JP)

Correspondence Address: MARTIN NOVACK, 16355 VINTAGE OAKS LANE, DELRAY BEACH, FL, 33484, US

(73) Assignee: KDDI Corporation

(21) Appl. No.: 11/328,398

(22) Filed: Jan. 9, 2006

(30) Foreign Application Priority Data
Jan. 11, 2005 (JP) 3917/2005

(51) Int. Cl. H04Q 7/00; H04J 3/16

(52) U.S. Cl. 370/329; 370/346

(57) ABSTRACT

The present invention relates to an method of medium access control for a wireless system that makes possible a subscriber station located out of coverage area of a base station communicate with the base station with the help of a relay station. The method includes broadcasting a polling packet by the relay station during the contention period, receiving the polling packet by the relayed subscriber station, transmitting a packet by the relayed subscriber station to the relay station during a predetermined period, and transmitting the packet to the base station by the relay station in the contention period after passing the predetermined period.

### PRIORITY CLAIM

This application claims priority from Japanese patent application No. 2005-003917, filed on Jan. 11, 2005, which is incorporated herein by reference.

### BACKGROUND OF THE INVENTION

1. Field of the Invention

The present invention relates to a method of medium access control for a wireless system and a relay station used in the wireless system.

2. Description of the Related Art

For wireless local area network (LAN), it has been widely used a system in accordance with IEEE 802.11 standard. Also practical application of high data rate wireless access system, such as IEEE 802.16, is studied. IEEE 802.16 is a standard for broadband wireless access (BWA) used in wireless metropolitan area network (MAN), realizes wider coverage area and higher data rate compared to IEEE 802.11, and performs quality of service (QoS) control precisely. Especially, it achieves data rate more than 120 Mbps at 2 GHz to 66 GHz frequency band, if line-of-sight is available.

There is a wireless system that a base station (BS) controls medium access with one or more subscriber stations (SS) placed in its coverage area. This system is defined as infrastructure mode in IEEE 802.11 and as point-to-multipoint (PMP) mode in IEEE 802.16. In these modes, communication method between a base station and subscriber stations via relay station (RS) is not specified.

On the contrary, there is another wireless system that has no base station BS, and subscriber stations establish peer-to-peer or multi hop network autonomously. This system is defined as ad hoc mode in IEEE 802.11, and defined as mesh mode in IEEE 802.16. In accordance with these modes, one subscriber station communicates with another subscriber station via one or more subscriber stations, that is multi hop configuration.

In IEEE 802.11, wireless distribution system (WDS) is also defined. With WDS, packets can be relayed between base stations configured as infrastructure mode. This system is under consideration by the task group S of IEEE 802.11.

Further, even if a first subscriber station and a second subscriber station can communicate with an access point of wireless LAN system, collision between packets, which is sent by these subscribers, may occur, in case the first subscriber station and the second subscriber station can not communicate each other. This problem is referred as “hidden terminal problem”. For “hidden terminal problem”, IEEE 802.11 specifies a request to send (RTS) message and a clear to send (CTS) message. JP patent publication 2001-231078 disclose the method for controlling packet transmission between relay stations using RTS/CTS packets, to avoid bad effect on one relay station caused by the packet from other relay stations. This method makes processing time for relaying short, and avoids packets from staying in one relay station for a long time.

More precisely, for receiving confirmation of data packets from a first relay station, a second relay station sends a RTS packet to the first relay station, instead of an ACK packet. The first relay station recognizes the second relay station receives data packets by receiving the RTS packet from the second relay station, and stop packets transmission for the period described in the RTS packet. The RTS packet sent from the second relay station is also received by a third relay station. The third relay station sends a CTS packet to the second relay station after SIFS (Short InterFrame Space) period, if the third relay station is ready to receive data packets. The second relay station recognizes the third relay station is ready by receiving the CTS packet from the third relay station, and sends data packets to the third relay station after SIFS period.

Regarding as the above mentioned art, it is impossible to use ad hoc mode and infrastructure mode simultaneously in accordance with IEEE 802.11, because it requires to set identification flag that indicates the operation mode in the frame. Also it is impossible to use mesh mode and PMP mode simultaneously in accordance with IEEE 802.16, because a frame structure used in the mesh mode and one used in the PMP mode is completely different, and is not compatible. Therefore, subscriber station, which is out of coverage area of a base station, cannot communicate with the base station, even if there is a relay station, with which the subscriber station can communicate, in the coverage area of the base station. Especially, in case of the system based on the IEEE 802.16 standard, it is distant, because operating mode of the whole system must be changed.

Furthermore, data throughput of mesh mode decreases compared to the one of PMP mode, because mesh mode need to send more management information than PMP mode. Also mesh mode is defined as optional, a subscriber station, which is implemented only PMP mode, cannot communicate with base station via relay station.

Because the system in accordance with IEEE 802.16 is used with the frequency band above 2 GHz, which is very sensitive to the land feature and buildings, communication is easy to unstable. Therefore, if the subscriber station is in the building or basement, it could not probably communicate with the base station. In this case, new base station should be provided.

### BRIEF SUMMARY OF THE INVENTION

The invention has been made in view of the above-mentioned problem, and it is therefore an object of the present invention to provide a method for medium access control of a wireless system that makes possible a subscriber station located out of coverage area of a base station can communicate with the base station via a relay station, which is in the coverage area of the base station. The present invention also provides the relay station used in the wireless system.

According to the present invention, a method of medium access control for a wireless system, which has a base station, a relay station that can communicate with the base station, a first subscriber station that can communicate with the base station, and a second subscriber station that can communicate with the relay station, but can not communicate with the base station, the method includes the steps of broadcasting a polling packet by the relay station during the contention period, receiving the polling packet by the second subscriber station, transmitting a packet by the second subscriber station to the relay station during a predetermined period, and transmitting the packet to the base station by the relay station in the contention period after passing the predetermined period. The first subscriber station stops transmitting any packets during the predetermined period, in case it receives the polling packet.

Favorably, the method is applied to the system in accordance with the distributed coordinated function (DCF) of IEEE 802.11 standard, and the contention period is provided after DCF interframe space (DIFS).

Favorably, the method is applied to the system in accordance with point to multipoint mode of the IEEE 802.16 standard, and the packet transmitted from the second subscriber station to the base station via the relay station is for a ranging request (RNG-REQ) message or for a bandwidth request (BW-REQ) message.

Advantageously, the method further includes the step of broadcasting a downlink frame by the relay station to the second subscriber station, in case the relay station receives the downlink frame from the base station, and transmitting the RNG-REQ message or the BW-REQ message after passing the predetermined period, in case the relay station receives the RNG-REQ message or the BW-REQ message from the second subscriber station.

Favorably, the relay station sets the value of start time field of both DL-MAP and UL-MAP included in the broadcasting downlink frame, the value is subtracted transmission delay between the base station and the relay station from a value in the start time field of DL-MAP and UL-MAP included in the receiving downlink frame from the base station.

According to another aspect of the present invention, a relay station is used for a wireless system, which has a base station, a first subscriber station that can communicate with the base station, and a second subscriber station that can communicate with the relay station, but can not communicate with the base station. The relay station can communicate with the base station, and includes means for transmitting a polling packet, which makes the first subscriber station stop transmitting any packets, during the contention period, means for receiving a packet from the second subscriber station in the contention period, and means for transmitting the packet received from the second subscriber station to the base station after passing a predetermined period.

Favorably, the relay station is applied to the system in accordance with the distributed coordinated function (DCF) of IEEE 802.11 standard and the contention period is provided after DCF interframe space (DIFS).

Favorably, the relay station is applied to the system in accordance with point to multipoint mode of the IEEE 802.16 standard, and the packet transmitted from the second subscriber station to the base station via the relay station is for a ranging request (RNG-REQ) message or for a bandwidth request (BW-REQ) message.

Advantageously, the relay station further includes means for broadcasting a downlink frame to the second subscriber station, in case the relay station receives the downlink frame from the base station, and means for transmitting the RNG-REQ message or the BW-REQ message to the base station after passing the predetermined period, in case the relay station receives the RNG-REQ message or the BW-REQ message from the second subscriber station.

Advantageously, the relay station further includes means for setting a value of start time field of both DL-MAP and UL-MAP included in the broadcasting downlink frame, where the value is subtracted transmission delay between the base station and the relay station from a value in the start time field of DL-MAP and UL-MAP included in the receiving downlink frame from the base station.

According to further aspect of the present invention, the relay station is implemented by computer program, which is stored on a computer readable medium.

According to the present invention, the base station can communicate with the subscriber station located out of coverage area of the base station via the relay station. That is, the present invention makes wider the coverage area of the base station with the simple relay station.

Especially, point to multipoint mode of IEEE 802.16 requires fewer overheads than the mesh mode of it, therefore it does not reduce the throughput. Also the subscriber station that is implemented only point to multipoint mode can communicate with the base station with the help of the relay station.

### BRIEF DESCRIPTION OF THE DRAWINGS

FIG. 1 is a sequence diagram of the present invention being applied to a wireless LAN system in accordance with IEEE 802.11;

FIG. 2 is a first sequence diagram of the present invention being applied to the wireless broadband access system in accordance with IEEE 802.16;

FIG. 3 is a second sequence diagram of the present invention being applied to the wireless broadband access system in accordance with IEEE 802.16;

FIG. 4 is a third sequence diagram of the present invention being applied to the wireless broadband access system in accordance with IEEE 802.16;

FIG. 5 shows a structure of DL-MAP sent by the relay station;

FIG. 6 shows a structure of UL-MAP sent by the relay station;

FIG. 7 is a fourth sequence diagram of the present invention being applied to the wireless broadband access system in accordance with IEEE 802.16;

FIG. 8 shows a frame structure of a polling packet according the present invention;

FIG. 9 shows a frame structure of a RNG-REQ message sent by the subscriber station to the relay station;

FIG. 10 shows a frame structure of a RNG-REQ message sent by the relay station to the base station;

FIG. 11 is a fifth sequence diagram of the present invention being applied to the wireless broadband access system in accordance with IEEE 802.16;

FIG. 12 is a sixth sequence diagram of the present invention being applied to the wireless broadband access system in accordance with IEEE 802.16; and

FIG. 13 shows a frame structure in accordance with IEEE 802.16.

### DETAILED DESCRIPTION OF THE INVENTION

An embodiment of the present invention will be described below with reference to the drawings.

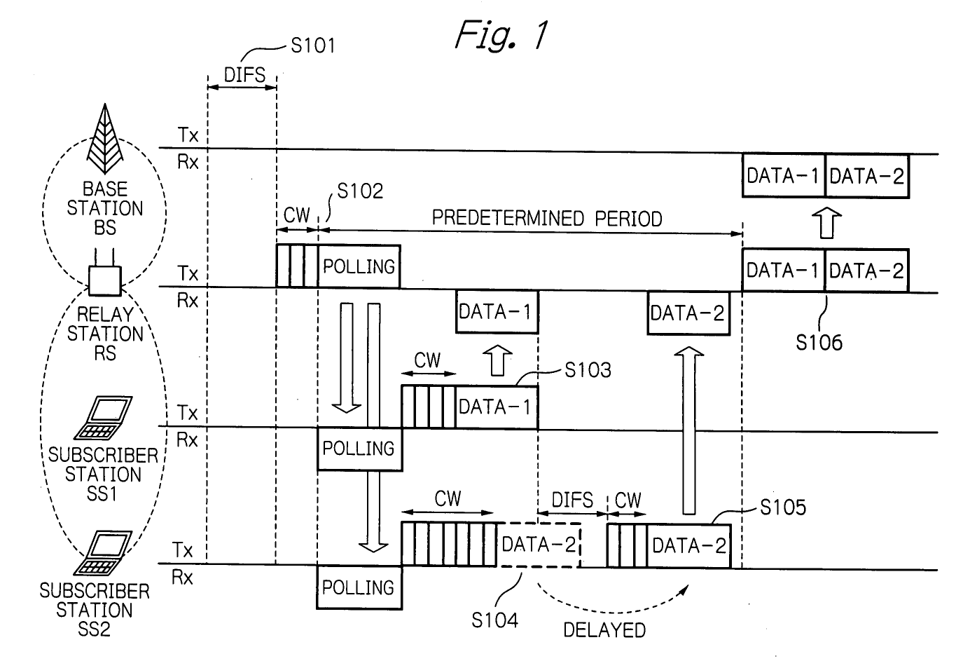

FIG. 1 is a sequence diagram of the present invention being applied to a wireless LAN system in accordance with IEEE 802.11.

The wireless system shown in FIG. 1 has a base station BS, a relay station RS that can communicate with the base station BS and one or more subscriber stations SS that cannot communicate with the base station BS, but can communicate with the relay station RS.

The relay station RS waits until DIFS period, which is the predetermined period in the contention period, is over according to the DCF (Step S101). After DIFS period, the relay station RS further waits until back-off period is over. The back-off period is calculated based on contention windows (CW) generated randomly at each station (Step S102). Then the relay station RS senses the carrier in the system to detect packet transmission from other stations. In case there is no data packet transmission, the relay station RS broadcasts a polling packet. The polling packet has predetermined format that is recognized by all stations, and CTS packet with broadcast address for destination address field can be used for it. Subscriber stations SS1 and SS2 receive the polling packet transmitted by the relay station RS.

According to the present invention, the polling packet sent by the relay station RS is also received by the base station BS as well as other subscriber stations, which can communicate with the base station BS. The base station BS and other subscriber stations that do not require the relay station RS stop sending any packets for predetermined period. On the contrary, the subscriber stations, which send data packets to the base station BS via the relay station RS, shift to contention period state by receiving the polling packet, and can send data packets.

The subscriber station SS1 that receives the polling packet waits until the back-off period, which is also calculated based on CWs generated randomly at the subscriber station SS1, is over. Then the subscriber station SS1 sends data packets after confirming no carrier from other stations (Step S103). The subscriber station SS2 that receives the polling packet also waits until the back-off time is over, and then confirms whether data packets can be transmitted or not, as the subscriber station SS1 does. Because the subscriber station SS2 detect data packets sent by the subscriber station SS1, data packet transmission is delayed. Therefore no collision occurs, and the relay station RS receives data packets from the subscriber station SS1 (Step S104). After DIFS period, the subscriber station SS2 further waits until the back-off period is over, and then sends data packets, which were delayed to avoid the collision, to the relay station RS (Step S105). After predetermined period from sending the polling packet, the relay station RS shift to contention period state with the base station BS, and sends data packets received from the subscriber stations SS1 and SS2 (Step S106).

Next, the sequence diagram of the present invention, which is applied to a wireless broadband access system in accordance with IEEE 802.16, is explained.

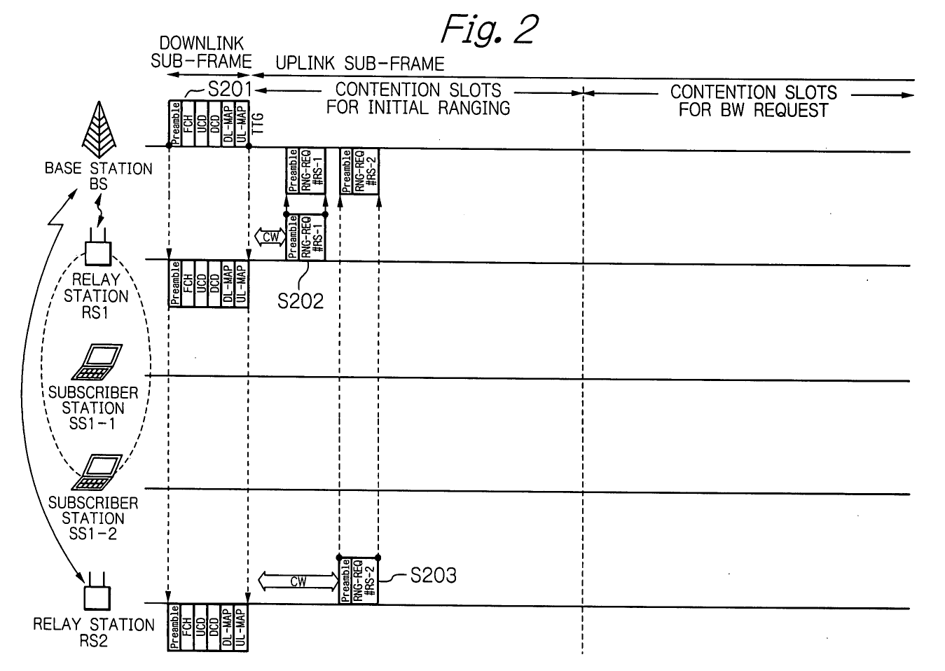

According to the present invention, PMP mode is used as the network topology. As shown in FIG. 2, a wireless system has a relay station RS1 and a relay station RS2, both of which are in the coverage area of a base station BS. Also it has subscriber stations SS-1 and SS-2, both of which are located out of coverage area of the base station BS, but in coverage area of the relay station RS1.

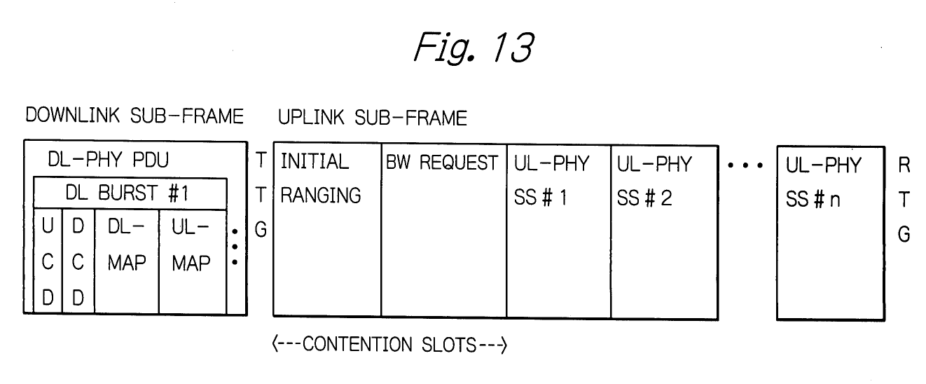

According to the IEEE 802.16, data transmission on downlink and uplink is performed alternately and synchronously, where downlink is the link from a base station to subscriber stations, and uplink is the link from a subscriber station to a base station. A frame structure based on time division duplex (TDD) has a downlink sub-frame and an uplink sub-frame as shown in FIG. 13, each of them has a plurality of physical slots (PS). It is possible to adjust the position of Tx/Rx transition gap (TTG), which is boundary of the downlink sub-frame and the uplink sub-frame, and it means transmission bandwidth of downlink and uplink can be configured as asymmetrically.

The downlink sub-frame includes preamble, FCH and DL burst #k, where k is integer. DL burst #1 includes UCD (Uplink Channel Descriptor), which is the uplink channel information, DCD (Downlink Channel Descriptor), which is the downlink channel information, DL-MAP and UL-MAP. The uplink sub-frame following TTG includes contention slots for initial ranging, contention slots for BW request (BandWidth Request) and one or more data fields for each subscriber station. The initial ranging and BW request are within the contention period, and data fields are within the contention free period.

FIG. 2 is a first sequence diagram of the present invention being applied for the wireless broadband access system in accordance with IEEE 802.16.

The base station BS broadcasts the downlink sub-frame including UCD, DCD, DL-MAP and UL-MAP. This downlink sub-frame is received by the relay stations RS1 and RS2, each of which are located inside the coverage area of the base station BS. The relay station RS1 and RS2 establish synchronization with the base station BS, when they receive the downlink sub-frame from the base station BS (Step S201). The relay station RS1 sends a RNG-REQ (Ranging Request) message to the base station BS during the initial ranging period after TTG, which is the boundary of the downlink sub-frame and uplink sub-frame. The information for adjusting timing and transmission power is included in the RNG-REQ message. Preferably, it may use CSMA/CA (Carrier Sense Multiple Access with Collision Avoidance), which is the method each station sends data packet after confirming no carrier on the transmission medium for predetermined period, for packets transmission during the contention slots. The RNG-REQ message is sent after back-off period corresponding to the contention windows (Step S202). The relay station RS2 also sends a RNG-REQ message to the base station BS during initial ranging period (Step S203).

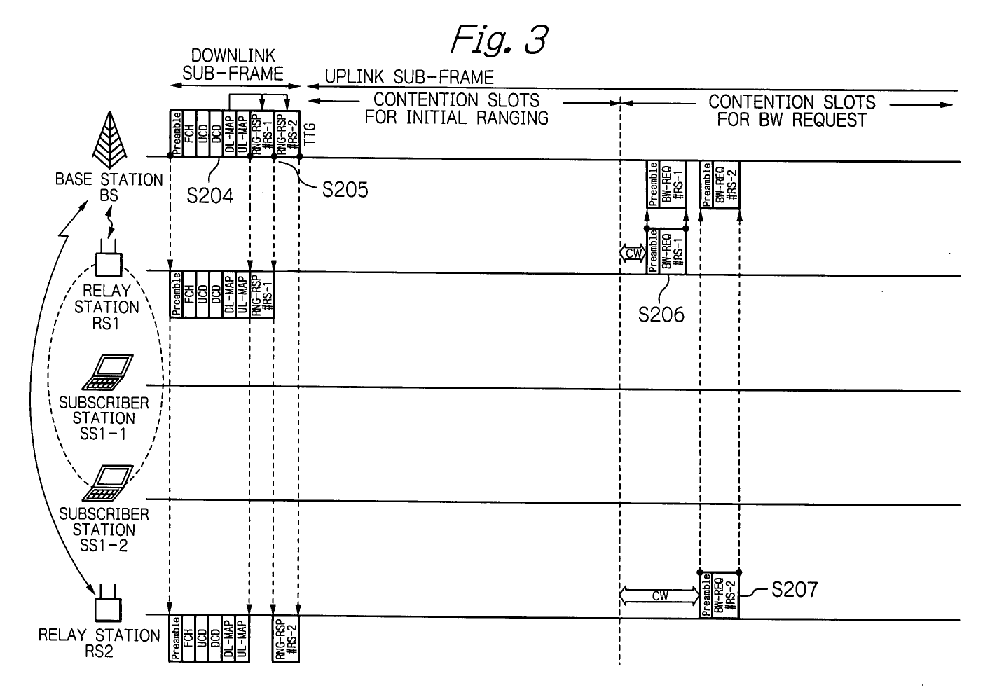

FIG. 3 is a second sequence diagram of the present invention being applied to the wireless broadband access system in accordance with IEEE 802.16.

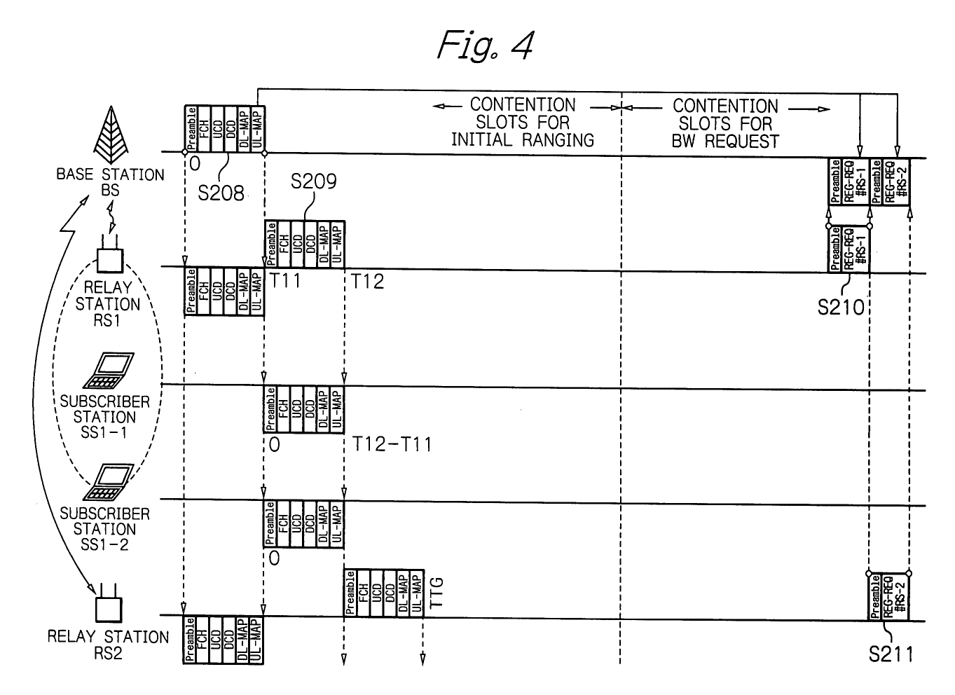

The base station BS broadcasts the downlink sub-frame including UCD, DCD, DL-MAP and UL-MAP (Step S204). This downlink sub-frame also includes a RNG-RSP (Ranging Response) message, which is the reply against the RNG-REQ message sent by the relay stations RS1 and RS2. The relay stations RS1 and RS2 complete ranging by receiving the RNG-RSP message (Step S205). The relay station RS1 sends a BW-REQ message (Bandwidth Request) to the base station BS during the bandwidth request period in the contention slots after TTG, which is the boundary of the downlink sub-frame and uplink sub-frame. Preferably, the BW-REQ message may be transmitted based on CSMA/CA. The BW-REQ message is for requesting bandwidth for a REG-REQ (Registration Request) message transmitted in the next phase shown in FIG. 4. The BW-REQ message is sent after backoff period corresponding to the contention windows (Step S206). The relay station RS2 also sends a BW-REQ message to the base station BS during the bandwidth request period in the contention slots (Step S207).

FIG. 4 is a third sequence diagram of the present invention being applied to the wireless broadband access system in accordance with IEEE 802.16.

The base station BS broadcasts the downlink sub-frame including UCD, DCD, DL-MAP and UL-MAP (Step S208). The relay station RS1 broadcasts the downlink sub-frame received from the base station BS. The subscriber stations SS1-1 and SS1-2 establish synchronization with the relay station RS, when they receive the downlink sub-frame from the relay station RS1. The relay station RS2 also broadcasts the downlink sub-frame received from the base station BS. (Step S209). The relay station RS1 sends a REG-REQ message to the base station BS after contention slots. The REG-REQ message is transmitted in accordance with UL-MAP, which is generated as the reply of the BW-REQ message, and transmitted during the contention free period (Step S210). The relay station RS2 also sends a REG-REQ message to the base station BS (Step S211).

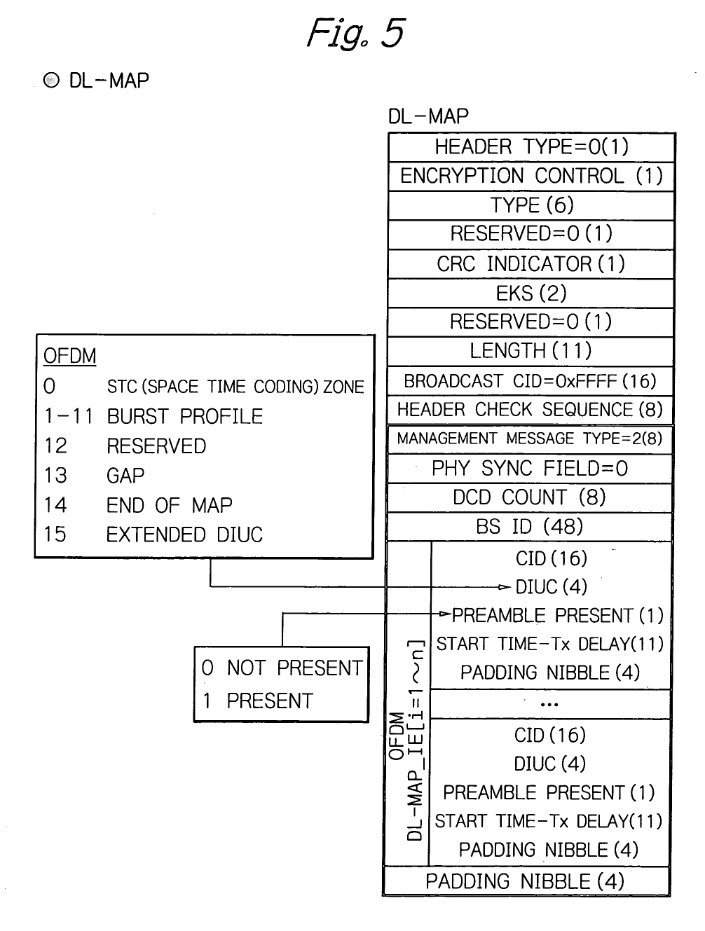

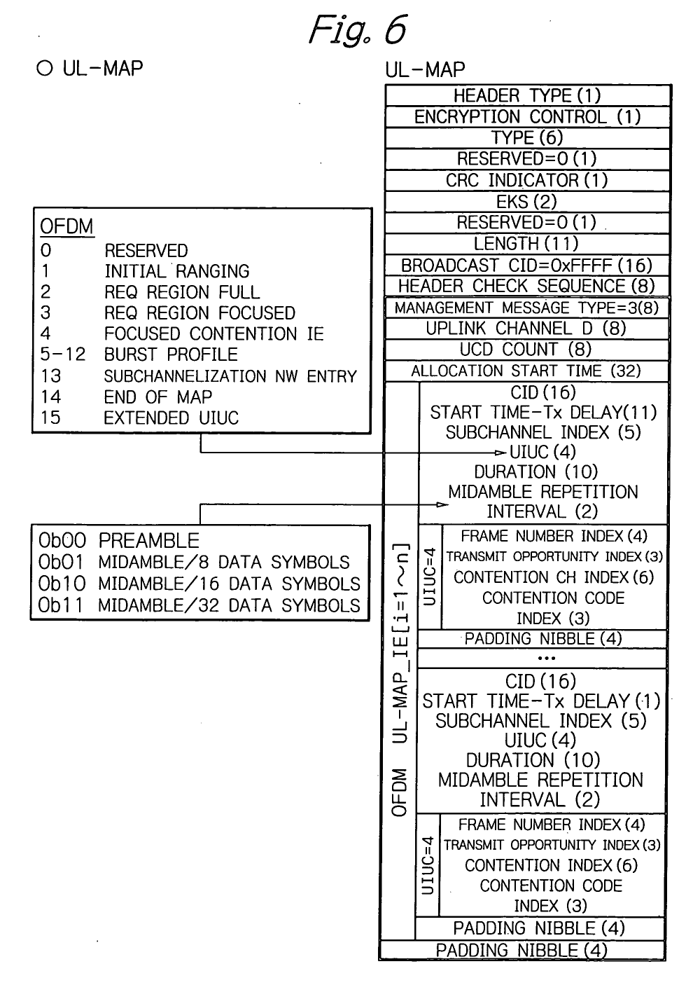

FIG. 5 shows a structure of DL-MAP sent by the relay stations RS1 and RS2. FIG. 6 shows a structure of UL-MAP sent by the relay stations RS1 and RS2.

According to the invention, the relay stations RS1 and RS2 change the value of start time in the DL-MAP and UL-MAP. More precisely, start time in the DL-MAP and UL-MAP sent to subscriber stations has the value that is subtracted transmission delay time from the start time in the DL-MAP and UL-MAP sent by the base station BS. For example, the downlink sub-frame sent by the base station BS at step S208 in FIG. 4 reaches to the relay station RS1 T11 time later. Therefore the relay station RS1 broadcasts downlink sub-frame T11 time later. For the subscriber stations SS1-1 and SS1-2, the time when the relay station RS1 broadcasts downlink sub-frame is reference. Therefore start time in the DL-MAP and UL-MAP to the subscriber stations SS1-1 and SS1-2 has a value that is subtracted transmission delay T11 from the start time in the DL-MAP and UL-MAP received from the base station BS. If no subtraction is performed, the subscriber stations SS1-1 and SS1-2 may need to wait extra time up to the transmission delay T11.

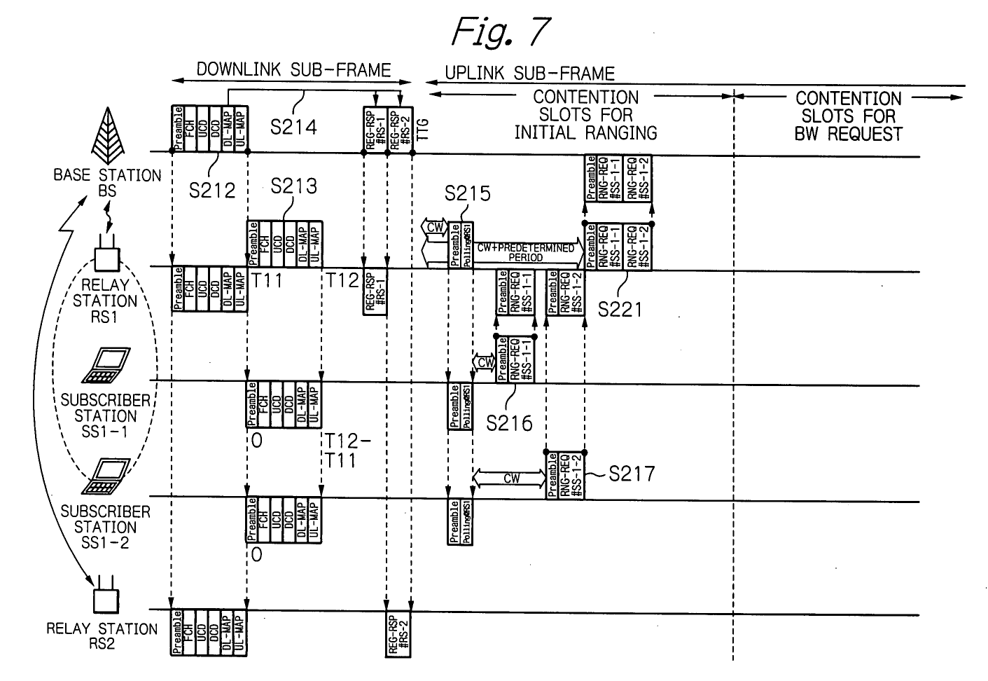

FIG. 7 is a fourth sequence diagram of the present invention being applied to the wireless broadband access system in accordance with IEEE 802.16.

The base station BS broadcasts the downlink sub-frame including UCD, DCD, DL-MAP and UL-MAP (Step S212). The relay station RS1 broadcasts the downlink sub-frame received from the base station BS (Step S213). This downlink sub-frame also includes REG-RSP messages, which are reply against REG-REQ messages sent by the relay stations RS1 and RS2. The relay stations RS1 and RS2 complete registration process by receiving the REG-RSP message (Step S214). The relay station RS1 broadcasts a polling packet during the initial ranging period in the contention slots after TTG. Preferably, the polling packet may be transmitted based on CSMA/CA. The polling packet is transmitted after backoff time period corresponding to the contention windows generated randomly (Step S215).

The base station BS and other subscriber stations, as well as the subscriber stations SS1-1 and SS1-2 receive the polling packet sent by the relay station RS1. The subscriber stations SS1-1 and SS1-2 shift to contention period state for predetermined period by receiving the polling packet from the relay station RS1, and are granted permission to send a RNG-REQ message to the relay station RS1. However, the base station BS and other stations, which do not use the relay station RS1, stop sending any packets while the contention period for the subscriber stations SS1-1 and SS1-2.

The subscriber station SS1-1 sends a RNG-REQ message to the relay station RS1 during contention period. The RNG-REQ message is transmitted after backoff period, such as CSMA/CA method. The RNG-REQ message includes burst profile, which indicates modulation type and coding rate to be used between the relay station RS and the subscriber station SS1-1. (Step S216). The subscriber station SS1-2 also sends a RNG-REQ message, which has a burst profile, to the relay station RS1 during contention period (Step S217). The relay station RS1 sends both RNG-REQ messages from the subscriber stations SS1-1 and SS1-2 together to the base station BS. The contents of the RNG-REQ messages from the subscriber stations SS1-1 and SS1-2 are changed before sending it to the base station BS, because the destination of these messages are changed.

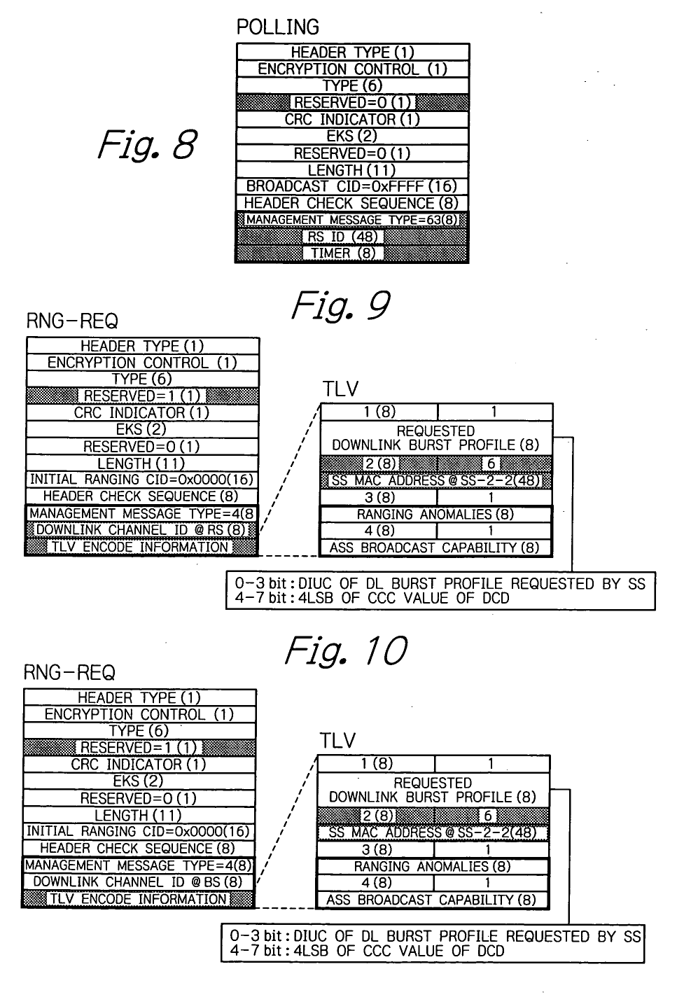

FIG. 8 shows a frame structure of the polling packet according the present invention.

As shown in FIG. 8, the polling packet includes management message type, which has the value to indicate polling packet, identification of the relay station RS and time for contention period for the relayed subscriber stations. Other relay stations and other subscriber stations do not send any packet during the time indicated in the polling packet. The subscriber stations that use the relay station, such as the subscriber stations SS1-1 and SS1-2, shift to contention period state for the time indicated in the received polling packet.

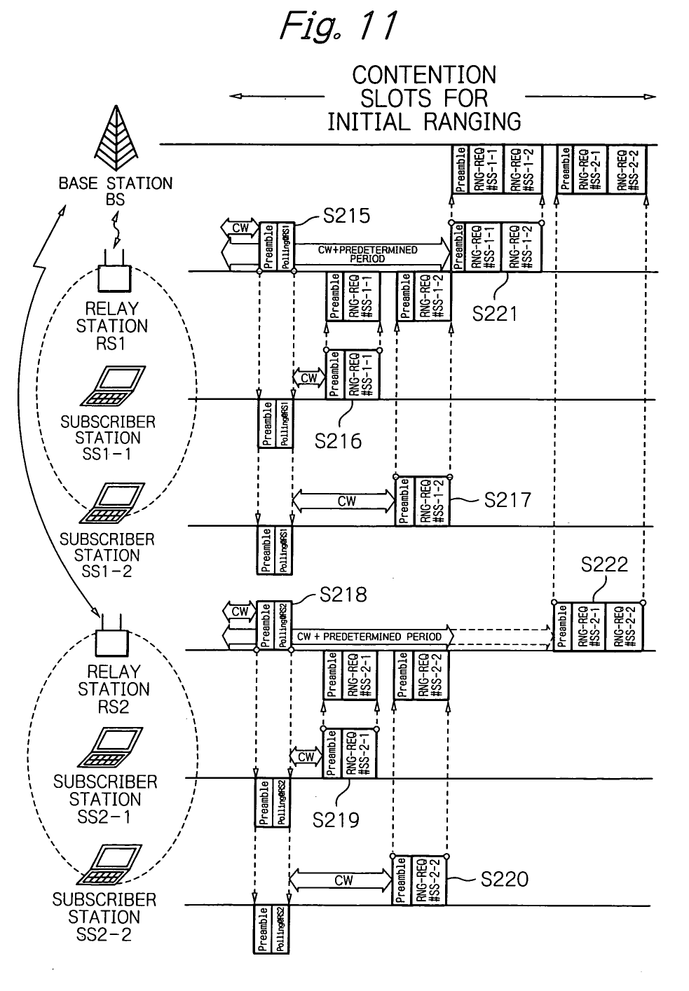

FIG. 9 shows a frame structure of the RNG-REQ message sent by the subscriber station to the relay station RS. FIG. 10 shows frame structure of the RNG-REQ message sent by the relay station RS to the base station BS. The relay station RS changed RNG-REQ shown in FIG. 9 to RNG-REQ shown in FIG. 10, when the relay station sends it to the base station BS.

FIG. 11 is a fifth sequence diagram of the present invention being applied to the wireless broadband access system in accordance with IEEE 802.16.

Step S215 to S217 in FIG. 11 is the same as the step S215 to S217 in FIG. 7, and is corresponding to step S218 to S220 in FIG. 11, which is the sequence between the relay station RS2 and the subscriber stations SS2-1 and SS2-2. As shown in FIG. 11, step S215 to S217 and step S218 to S220 can be performed simultaneously. To do this, initial ranging period in the contention slots can be reduced. But for simultaneous operation, the different frequency is assigned for the relay stations RS1 and RS2, or physical distance between the relay stations RS1 and RS2 must be far enough to avoid interference, if both relay stations use the same frequency.

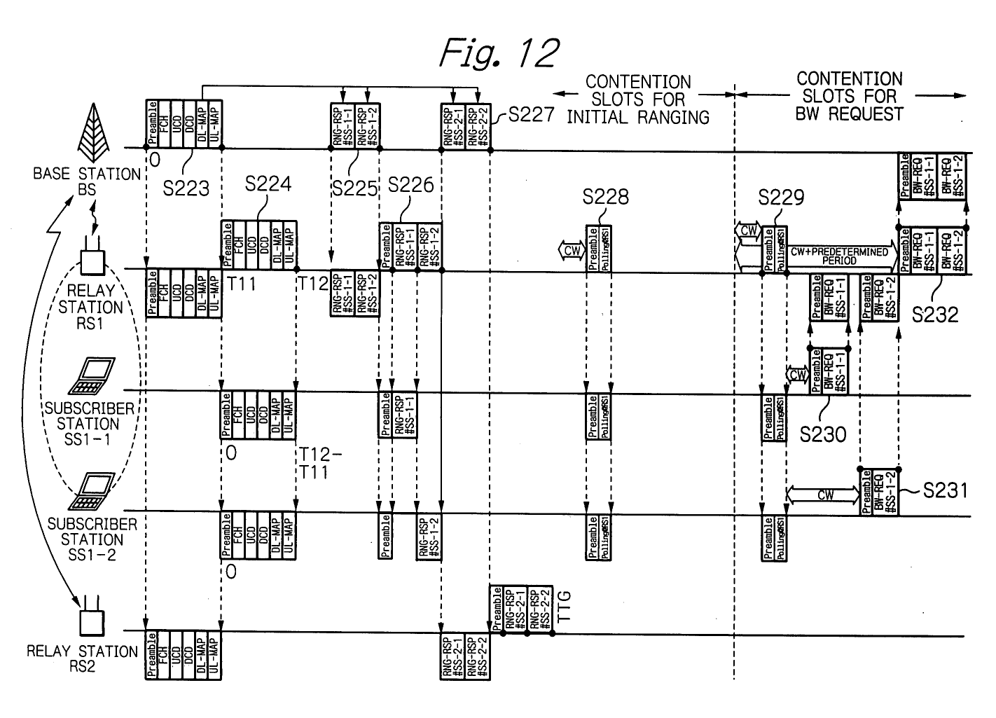

FIG. 12 is a sixth sequence diagram of the present invention being applied to the wireless broadband access system in accordance with IEEE 802.16.

The base station BS broadcasts the downlink sub-frame including UCD, DCD, DL-MAP and UL-MAP (Step S223). The relay station RS1 broadcasts the downlink sub-frame including UCD, DCD, DL-MAP and UL-MAP received from the base station to the relayed subscriber stations (Step S224). The downlink sub-frame broadcasted by the base station BS also includes RNG-RSP messages, which are reply against REG-REQ messages sent by the relay station RS1 (Step S225), for the subscriber stations SS1-1 and SS1-2. The relay station RS1 transmits RNG-RSP messages from the base station BS to the subscriber stations SS1-1 and SS1-2. The subscriber stations SS1-1 and SS1-2 complete ranging by receiving a RNG-RSP message from the relay station RS1 (Step S226). The downlink sub-frame broadcasted by the base station BS also includes RNG-RSP messages, which are reply against REG-REQ messages sent by the relay station RS2 (Step S227).

The relay station RS1 broadcasts a polling packet during the initial ranging period in the contention slots after TTG. Because the subscriber stations SS1-1 and SS1-2 have already completed ranging, the subscriber stations SS1-1 and SS1-2 do not send any packets. (Step S228).

The relay station RS1 broadcasts a polling packet during the bandwidth request period in the contention slots. The polling packet is transmitted after backoff period, such as CSMA/CA method (Step S229).

The base station BS and other subscriber stations, as well as the relayed subscriber stations SS1-1 and SS1-2 receive the polling packet sent by the relay station RS1. The subscriber stations SS1-1 and SS1-2 shift to contention period state for predetermined time period by receiving the polling packet from the relay station RS1, and are granted permission to send a BW-REQ message to the relay station RS1. However, the base station BS and other stations, which do not use the relay station RS1, stop sending any packets while the contention slots for the subscriber stations SS1-1 and SS1-2.

The subscriber station SS1-1 sends the BW-REQ message for the registration procedure to the relay station RS1 during the contention period. The BW-REQ message is transmitted after backoff period, such as CSMA/CA method. (Step S230). The subscriber station SS1-2 also sends a BW-REQ message to the relay station RS1 during contention period (Step S231). The relay station RS1 sends both BW-REQ messages from the subscriber stations SS1-1 and SS1-2 together to the base station BS. The contents of the BW-REQ from the subscriber stations SS1-1 and SS1-2 are changed before sending it to the base station BS, because the destination of these messages are changed.

Then, the subscriber stations, which uses relay station RS1, sends a REG-REQ message based on the UL-MAP to the relay station RS1, and the relay station RS1 sends the REG-REQ message received from the subscriber stations to the base station BS. The subscriber stations SS1-1 and SS1-2 complete registration procedure when they receive a REG-RSP message from the base station BS via the relay station RS1. After registration, transmission is performed in accordance with IEEE 802.16. For the best effort service, the relay station RS1 relays a BW-REQ message for dynamic service addition (DSA) using the polling packet.

The embodiment described here is given merely as example, and a person skilled in the art can implement other embodiments of the invention, which are within the scope of the invention.

1. A method of medium access control for a wireless system comprising a base station, a relay station being able to communicate with the base station, a first subscriber station being able to communicate with the base station, and a second subscriber station being unable to communicate with the base station and being able to communicate with the relay station, the method comprising the steps of:
broadcasting a polling packet by the relay station during the contention period;
receiving the polling packet by the second subscriber station;
transmitting a packet by the second subscriber station to the relay station during a predetermined period; and
transmitting the packet to the base station by the relay station in the contention period after passing the predetermined period,
wherein the first subscriber station stop transmitting any packets during the predetermined period, in case it receives the polling packet.

2. The method of claim 1, wherein the system is in accordance with the distributed coordinated function (DCF) of IEEE 802.11 standard and the contention period is provided after DCF interframe space (DIFS).

3. The method of claim 1, wherein the system is in accordance with point to multipoint mode of the IEEE 802.16 standard,
wherein the packet transmitted from the second subscriber station to the base station via the relay station is for a ranging request (RNG-REQ) message or for a bandwidth request (BW-REQ) message.

4. The method of claim 1, further comprising the step of:
broadcasting a downlink frame by the relay station to the second subscriber station, in case the relay station receives the downlink frame from the base station; and
transmitting the RNG-REQ message or the BW-REQ message by the relay station after passing the predetermined period, in case the relay station receives the RNG-REQ message or the BW-REQ message from the second subscriber station.

5. The method of claim 4, wherein the relay station sets the value of start time field of both DL-MAP and UL-MAP included in the broadcasting downlink frame, the value is subtracted transmission delay between the base station and the relay station from a value in the start time field of DL-MAP and UL-MAP included in the receiving downlink frame from the base station.

6. A relay station for a wireless system comprising a base station, a first subscriber station being able to communicate with the base station, and a second subscriber station being unable to communicate with the base station and being able to communicate with the relay station, the relay station being able to communicate with the base station, the relay station comprising:
means for transmitting a polling packet during the contention period, the polling packet making the first subscriber station stop transmitting any packets;
means for receiving a packet from the second subscriber station in the contention period; and
means for transmitting the packet received from the second subscriber station to the base station after passing a predetermined period.

7. The relay station of claim 6, wherein the system is in accordance with the distributed coordinated function (DCF) of IEEE 802.11 standard and the contention period is provided after DCF interframe space (DIFS).

8. The relay station of claim 6, wherein the system is in accordance with point to multipoint mode of the IEEE 802.16 standard,
wherein the packet transmitted from the second subscriber station to the base station via the relay station is for a ranging request (RNG-REQ) message or for a bandwidth request (BW-REQ) message.

9. The relay station of claim 8, further comprising:
means for broadcasting a downlink frame to the second subscriber station, in case the relay station receives the downlink frame from the base station; and
means for transmitting the RNG-REQ message or the BW-REQ message to the base station after passing the predetermined period, in case the relay station receives the RNG-REQ message or the BW-REQ message from the second subscriber station.

10. The relay station of claim 9, further comprising:
means for setting a value of start time field of both DL-MAP and UL-MAP included in the broadcasting downlink frame, the value is subtracted transmission delay between the base station and the relay station from a value in the start time field of DL-MAP and UL-MAP included in the receiving downlink frame from the base station.

11. A computer program product for a relay station for a wireless system comprising a base station, the relay station being able to communicate with the base station, a first subscriber station being able to communicate with the base station, and a second subscriber station being unable to communicate with the base station and being able to communicate with the relay station, the computer program product comprising:
first instruction means for transmitting a polling packet during the contention period, the polling packet making the first subscriber station stop transmitting any packets;
second instruction means for receiving a packet from the second subscriber station in the contention period; and
third instruction means for transmitting the packet received from the second subscriber station to the base station after passing a predetermined period.

12. The computer program product of claim 11, wherein the system is in accordance with the distributed coordinated function (DCF) of IEEE 802.11 standard and the contention period is provided after DCF interframe space (DIFS).

13. The computer program product of claim 11, wherein the system is in accordance with point to multipoint mode of the IEEE 802.16 standard,
wherein the packet transmitted from the second subscriber station to the base station via the relay station is for a ranging request (RNG-REQ) message or for a bandwidth request (BW-REQ) message.

14. The computer program product of claim 13, further comprising:
fourth instruction means for broadcasting a downlink frame to the second subscriber station, in case the relay station receives the downlink frame from the base station; and
fifth instruction means for transmitting the RNG-REQ message or the BW-REQ message to the base station after passing the predetermined period, in case the relay station receives the RNG-REQ message or the BW-REQ message from the second subscriber station.

15. The computer program product of claim 9, further comprising:
sixth instruction means for setting a value of start time field of both DL-MAP and UL-MAP included in the broadcasting downlink frame, the value is subtracted transmission delay between the base station and the relay station from a value in the start time field of DL-MAP and UL-MAP included in the receiving downlink frame from the base station.
